(19) United States
(12) Patent Application Publication
(10) Pub. No.: US 2025/0335505 A1
(43) Pub. Date: Oct. 30, 2025

(54) VIDEO PROCESSING DEVICE, VIDEO PROCESSING METHOD, AND COMPUTER PROGRAM PRODUCT

(71) Applicant: KABUSHIKI KAISHA TOSHIBA, Tokyo (JP)

(72) Inventor: Takehiko KAGOSHIMA, Yokohama (JP)

(73) Assignee: KABUSHIKI KAISHA TOSHIBA, Tokyo (JP)

(21) Appl. No.: 19/055,749

(22) Filed: Feb. 18, 2025

(30) Foreign Application Priority Data
Apr. 25, 2024 (JP) 2024-071484

(51) Int. Cl. G06F 16/783; G06F 16/732; G06F 16/738; G06V 20/40

(52) U.S. Cl. CPC G06F 16/783; G06F 16/732; G06F 16/738; G06V 20/49

(57) ABSTRACT

According to an embodiment, a video processing device receives text data representing a scene included in input first video data. The video processing device includes one or more hardware processors configured to function as an interpretation unit and a search unit. The interpretation unit interprets the text data and generates query information used to search for a video element of the first video data. The search unit searches for the video element of the first video data using the query information, generates metadata of the first video data based on a search result, and stores the metadata in a storage unit.

### CROSS-REFERENCE TO RELATED APPLICATIONS

This application is based upon and claims the benefit of priority from Japanese Patent Application No. 2024-071484, filed on Apr. 25, 2024; the entire contents of which are incorporated herein by reference.

### FIELD

Embodiments described herein relate generally to a video processing device, a video processing method, and a computer program product.

### BACKGROUND

A technology has been used with which metadata denoting a content of a video is added to video data, and the metadata is utilized to edit the video. For example, the related technology is known with which a video management device generates metadata by recognizing and converting a video element in a video into texts, edits the video to correspond to the metadata in response to the request of a user, and outputs the edited video.

However, with the conventional technology, it is difficult to enable video processing as intended by the user in response to the request of the user.

### BRIEF DESCRIPTION OF THE DRAWINGS

FIG. 1 is a diagram illustrating an example of a hardware configuration of a video processing device according to a first embodiment;

FIG. 2 is a diagram illustrating an example of a functional configuration of the video processing device according to the first embodiment;

FIG. 3 is a diagram illustrating an example of an operation screen of the video processing device according to the first embodiment;

FIG. 4 is a diagram illustrating an example of search result information acquired by a search unit according to the first embodiment;

FIG. 5 is a diagram illustrating an example of a functional configuration of an interpretation unit according to the first embodiment;

FIG. 6 is a diagram illustrating an example of an image query table according to the first embodiment;

FIG. 7 is a diagram illustrating a first example of a response text given by a response unit according to the first embodiment;

FIG. 8 is a diagram illustrating an example of a sound query table according to the first embodiment;

FIG. 9 is a diagram illustrating a second example of a response text given by the response unit according to the first embodiment;

FIG. 10 is a diagram illustrating an example of a closed caption query table according to the first embodiment;

FIG. 11 is a diagram illustrating a third example of a response text given by the response unit according to the first embodiment;

FIG. 12 is a diagram illustrating an example of query information according to the first embodiment;

FIG. 13 is a diagram illustrating an example of query information after adjusting query importance according to the first embodiment;

FIG. 14 is a diagram illustrating an example of a functional configuration of the search unit according to the first embodiment;

FIG. 15 is a flowchart illustrating an example of a video processing method according to the first embodiment;

FIG. 16 is a diagram illustrating an example of a functional configuration of a video processing device according to a second embodiment;

FIG. 17 is a diagram illustrating an example of a functional configuration of an interpretation unit according to the second embodiment;

FIG. 18 is a diagram illustrating an example of a face query table according to the second embodiment;

FIG. 19 is a diagram illustrating an example of a character query table according to the second embodiment;

FIG. 20 is a diagram illustrating an example of video attribute data according to the second embodiment;

FIG. 21 is a diagram illustrating an example of a response text given by a response unit according to the second embodiment;

FIG. 22 is a diagram illustrating an example of a voice query table according to the second embodiment;

FIG. 23 is a diagram illustrating an example of a response text given by the response unit according to the second embodiment;

FIG. 24 is a diagram illustrating an example of a functional configuration of the search unit according to the second embodiment; and

FIG. 25 is a flowchart illustrating an example of a video processing method according to the second embodiment.

### DETAILED DESCRIPTION

According to an embodiment, a video processing device receives text data representing a scene included in input first video data. The video processing device includes one or more hardware processors configured to function as an interpretation unit and a search unit. The interpretation unit interprets the text data and generates query information used to search for a video element of the first video data. The search unit searches for the video element of the first video data using the query information, generates metadata of the first video data based on a search result, and stores the metadata in a storage unit.

Exemplary embodiments of a video processing device, a video processing method, and a computer program product will be explained below in detail with reference to the accompanying drawings.

### First Embodiment

First, an example of a hardware configuration of a video processing device 200 according to a first embodiment will be explained.

### Example of Hardware Configuration

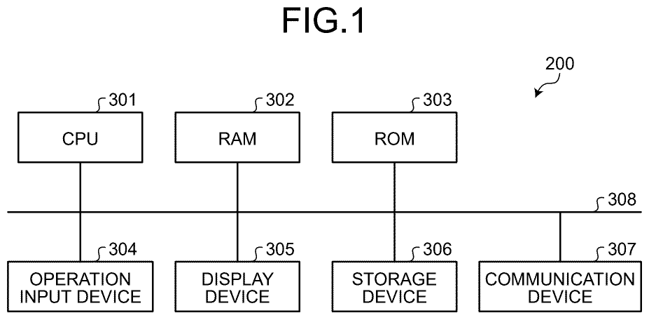

FIG. 1 is a diagram illustrating an example of the hardware configuration of the video processing device 200 according to the first embodiment. The example in FIG. 1 illustrates a case where the video processing device 200 according to the first embodiment is mounted on a computer such as a personal computer (PC).

The video processing device 200 according to the first embodiment includes a central processing unit (CPU) 301, a random access memory (RAM) 302, a read only memory (ROM) 303, an operation input device 304, a display device 305, and a storage device 306, and a communication device 307. The CPU 301, the RAM 302, the ROM 303, the operation input device 304, the display device 305, the storage device 306, and the communication device 307 are connected via a bus 308.

The CPU 301 is a processor that executes arithmetic processing, control processing, and the like according to a computer program. The CPU 301 uses a given area of the RAM 302 as a work area and executes various kinds of processing in cooperation with the computer program stored in the ROM 303, the storage device 306, and the like.

The RAM 302 is a memory such as a synchronous dynamic random access memory (SDRAM). The RAM 302 functions as the work area for the CPU 301. The ROM 303 is a memory that stores the computer program and various kinds of information in a non-rewritable manner.

The operation input device 304 is an input device such as a touch screen, a mouse, and a keyboard. The operation input device 304 receives information input from a user as an instruction signal, and outputs the instruction signal to the CPU 301.

The display device 305 is a display device such as a liquid crystal display (LCD). The display device 305 displays various kinds of information according to display signals from the CPU 301.

The storage device 306 is a semiconductor storage medium such as a flash memory. Furthermore, the storage device 306 is, for example, a device that writes and reads data to and from a magnetic or optically recordable storage medium or the like. The storage device 306 writes and reads data to and from a storage medium in response to control from the CPU 301.

The communication device 307 communicates with external devices via a network in response to control from the CPU 301.

### Example of Functional Configuration

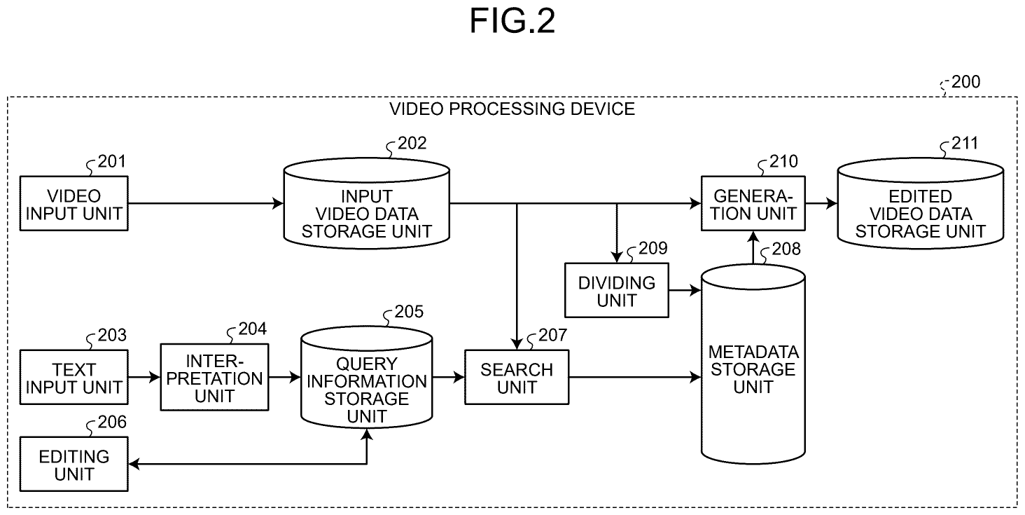

FIG. 2 is a diagram illustrating an example of the functional configuration of the video processing device 200 according to the first embodiment. The video processing device 200 according to the first embodiment extracts desired scenes from long-time video data by referring to texts representing the desired scenes input by the user, and generates digest video data in which the desired scenes are connected.

The video processing device 200 according to the first embodiment includes a video input unit 201, an input video data storage unit 202, a text input unit 203, an interpretation unit 204, a query information storage unit 205, an editing unit 206, a search unit 207, a metadata storage unit 208, a dividing unit 209, a generation unit 210, and an edited video data storage unit 211.

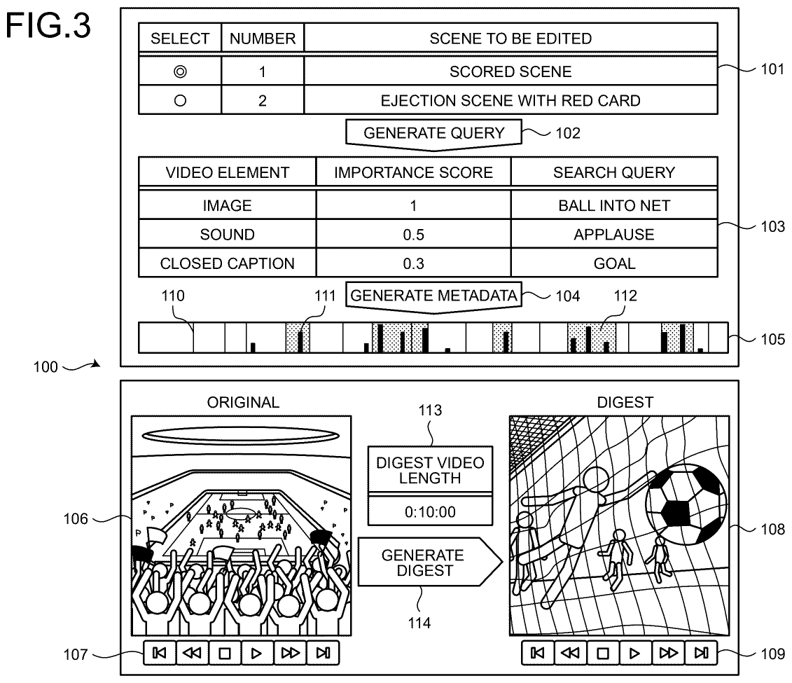

FIG. 3 is a diagram illustrating an example of an operation screen of the video processing device 200 according to the first embodiment. The example in FIG. 3 illustrates an example of an operation screen displayed on the display device 305 for operating the video processing device 200 according to the first embodiment. An operation screen 100 according to the first embodiment includes a scene input box 101, a query generation button 102, a query information edit box 103, a metadata generation button 104, a metadata display window 105, an original video display window 106, original video operation buttons 107, a digest video display window 108, a digest video operation button 109, a digest video length input box 113, and a digest generation button 114.

Operation examples of the video processing device 200 according to the first embodiment will be explained below with reference to FIG. 2 and FIG. 3.

The video input unit 201 receives input video data as an edit target (an example of first video data) by an operation input made by the user. While any input video data can be the edit target, the input video data may be a video of a soccer match or the like, for example.

The input video data storage unit 202 stores input video data indicated by the user. The input video data stored in the input video data storage unit 202 is displayed in the original video display window 106. The input video data stored in the input video data storage unit 202 is viewed by performing operations such as play, stop, fast forward, and fast reverse through operating the original video operation buttons 107.

The text input unit 203 acquires the text input by the user in the scene input box 101 at the timing where the query generation button 102 is pressed by the user. In the example in FIG. 3, two texts “scored scene” and “ejection scene with red card” are acquired.

The interpretation unit 204 generates query information used to search for a video element, from the texts acquired via the text input unit 203. A video element is the search target of the video data stored in the input video data storage unit 202. The video element includes an image, a sound, additional information, and the like. For example, additional information is a closed caption (an example of subtitle information) that is associated with time information of the video data.

For example, an image and a sound may be used as the video elements. Furthermore, for example, object, face of a person, character string, and the like in an image may be added as the video element. For example, voice, music, and the like in a sound may also be added as the video element. Closed captions and the like may also be added as additional information included in the video elements.

Query information includes a search query for searching for each of the video elements and an importance score for the search query (an example of query importance representing an importance degree of the search query). A search query is information that expresses the target to be searched from the video element with text, an image, a sound, and the like. An importance score is a numerical value that is indicative of the degree of relevance between the text acquired by the text input unit 203 and the search query. For example, the higher the value of the importance score, the greater the relevance (degree of association) between the text and the search query.

The query information storage unit 205 stores the query information output from the interpretation unit 204.

The editing unit 206 displays the query information stored in the query information storage unit 205 in the query information edit box 103, and accepts edit of search queries and importance scores from the user. The editing unit 206 updates the query information stored in the query information storage unit 205 based on the result of the edit accepted through the operation input from the user.

In the example in FIG. 3, an image, a sound, and a closed caption are the video elements. The search query for the image video element is “a ball into the net” for the input text “scored scene”, and the importance score thereof is 1. Furthermore, the search query for the sound video element is “applause” and the importance score thereof is 0.5, while the search query for the closed caption video element is “GOAL” and the importance score thereof is 0.3.

The editing unit 206 updates the query information in the query information storage unit 205 upon accepting edit of the search query and the importance score displayed in the query information edit box 103 from the user. For example, the editing unit 206 modifies “applause” to “applause and cheers” and corrects the importance score from 0.5 to 0.8 in accordance with the edit by the user. For example, the editing unit 206 deletes query information by each item (for example, deletes image in the video element, the importance score 1, and the search query “a ball into the net”) in accordance with the edit by the user. For example, the editing unit 206 also adds new query information (for example, adds a sound in the video element, the importance score 0.2, and the search query “whistle”) in accordance with the edit by the user.

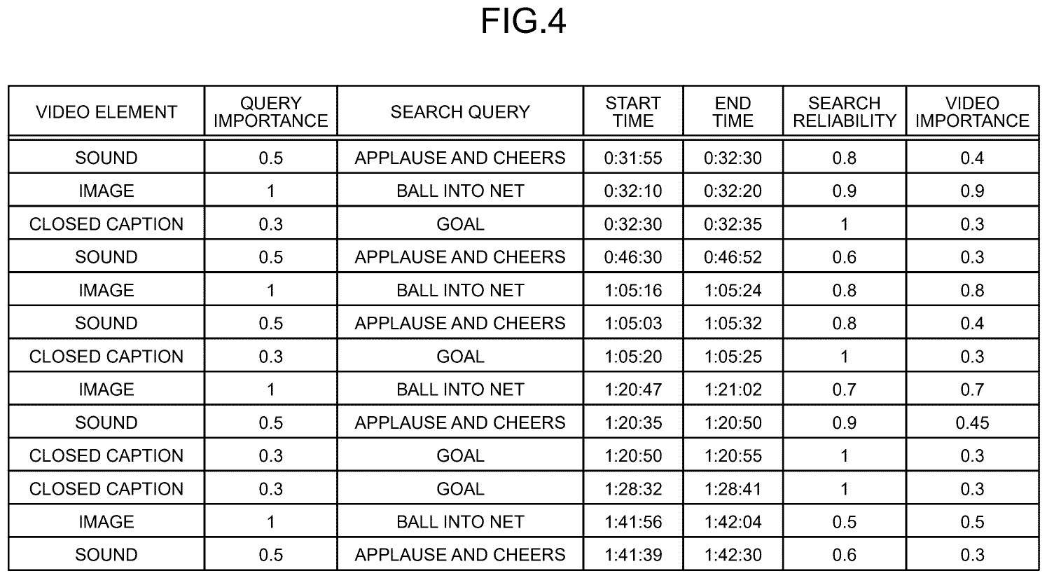

The search unit 207 searches for each piece of query information stored in the query information storage unit 205 from the video data stored in the input video data storage unit 202, and outputs the search result. The search result includes time information of the searched video segments and the video importance scores of the segments. An example of search result information is illustrated in FIG. 4.

FIG. 4 is a diagram illustrating an example of search result information acquired by the search unit 207 according to the first embodiment. The search result information according to the first embodiment includes a video element, a query importance, a search query, a start time, an end time, a search reliability, and a video importance.

The video element is indicative of a searched video element. The query importance is indicative of the importance degree of the query. The search query is indicative of the search query used for the search. The start time is indicative of the start time of the video segment that includes the searched video element. The end time is indicative of the end time of the video segment that includes the searched video element. The search reliability is indicative of the reliability degree of each search result calculated for each video segment that includes the searched video element. For example, as for the search reliability, a statistic such as the mean, maximum, or median of the search reliability for the video segment may be used.

The video importance is indicative of the importance degree of the video that includes the searched video element. In the example in FIG. 4, the video importance is the product of the query importance and the search reliability. Note that the segment length may also be taken into account by multiplying the video importance by a coefficient proportional to the video segment length. This allows, for example, the target that is on the video longer to have a higher video importance.

The example in FIG. 4 illustrates a case where the time information of a video segment is represented by the start time and the end time. However, the time information of a video segment may be represented by other values that are associated with the time, such as a frame numbers of the video. For example, the time information of a video segment may be expressed by the time at the center of the video segment and the length of the video segment (for example, 30 seconds or the like).

An example in which the search unit 207 according to the first embodiment detects the video segment that matches the search query is explained above. However, the whole segments of the video data stored in the input video data storage unit 202 may be divided into given segments, and the video importance may be calculated for each of the segments.

Returning to FIG. 2, the dividing unit 209 analyzes the video data stored in the input video data storage unit 202, and outputs scene boundary time information. A scene represents continuous segments of video data in terms of content. Scene segmentation can be achieved using various methods. For example, there is a method with which the boundary of shot that is from transition of a camera capturing the video to the next transition is detected, continuous shots with the similar content are connected into a scene unit, and boundary time of the scene unit is detected.

The boundary of the shots is detected, for example, by performing threshold-processing on the similarity between image frames (for example, the difference between feature values). Specifically, when the similarity between image frames is less than a given threshold, those image frames are detected to be different. When the similarity between image frames is equal to or greater than the given threshold, those image frames are detected to be the same.

A feature value representing the video content of a shot unit is represented, for example, by an averaging vector of feature vectors over shot segments in an image or voice frame unit, for example. Alternatively, a feature vector that is a concatenation of an image feature vector and a voice feature vector may be used as the feature value.

Furthermore, the dividing unit 209 may adjust the length of scenes by referring to parameters set in advance. For example, the parameters set in advance are an average scene length, a maximum scene length, a threshold for similarity of feature values per shot unit, and the like.

The metadata storage unit 208 stores metadata including the search result information output from the search unit 207 and the scene boundary time information output from the dividing unit 209. For example, the metadata includes time information indicative of the searched video segment and the above-described video importance indicative of the importance degree of the video segment. The search unit 207 calculates the video importance based on the reliability of the search result and the query importance described above.

Specifically, the search unit 207 and the dividing unit 209 execute processing at the timing where the metadata generation button 104 is pressed by the user, and the output of such processing is stored in the metadata storage unit 208 and reflected in the metadata display window 105.

In the example in FIG. 3, the horizontal axis of the metadata display window 105 represents the passage of time, with the left end representing the start of the video data stored in the input video data storage unit 202 and the right end representing the end of the video data. A thin line 110 separating the metadata display window 105 represents a scene boundary time. A thick bar 111 represents the search result, with the position in the horizontal direction representing the time information of the search result and the bar length in the vertical direction representing the video importance.

Then, when a desired digest video length is input by the user in the digest video length input box 113 and the digest generation button 114 is pressed, the generation unit 210 generates a digest video. Specifically, the generation unit 210 edits the video data stored in the input video data storage unit 202 by referring to the metadata stored in the metadata storage unit 208 to generate a digest video of the specified digest video length.

For example, the generation unit 210 edits the video data based on the video importance described above to generate a digest video (an example of second video data) that is shorter than the video data. First, the generation unit 210 calculates the scene importance of each scene unit by finding the sum of the video importance of the search result included in each scene. As for the scene importance, various statistics such as the mean or maximum, median of the video importance may be used. Then, the generation unit 210 sorts each of the scenes according to the scene importance, and selects the scenes to be employed for the digest video in a descending order. The generation unit 210 adds the scenes to the digest video until the sum total of the lengths of the selected scenes exceeds the designated digest video length.

For example, the generation unit 210 generates a digest video by selecting and concatenating scenes including video segments of greater video importance based on the given video length in the order of an earlier boundary time. Specifically, the generation unit 210 generates a digest video by concatenating scenes containing video segments of greater video importance in the order of the earlier boundary time until exceeding the designated digest video length. The generation unit 210 may also add scenes to the digest video such that the total length of the selected scenes becomes the longest within a range not exceeding the designated digest video length. Alternatively, scenes may be added until exceeding the digest video length, and then the last added scene may be truncated to match the designated digest video length.

In the example in FIG. 3, among each of the scenes divided by the lines 110 in the metadata display window 105, the scenes 112 colored in dark gray are the scenes employed for the digest video. The generation unit 210 reads the videos of the scenes employed for the digest video from the input video data storage unit 202, and concatenates the videos of the scenes to generate digest video data.

The edited video data storage unit 211 stores the digest video data output from the generation unit 210. The stored digest video is displayed in the digest video display window 108, and viewed by the user by operating the digest video operation buttons 109 (for example, play, stop, fast forward, fast reverse, and the like) by the user.

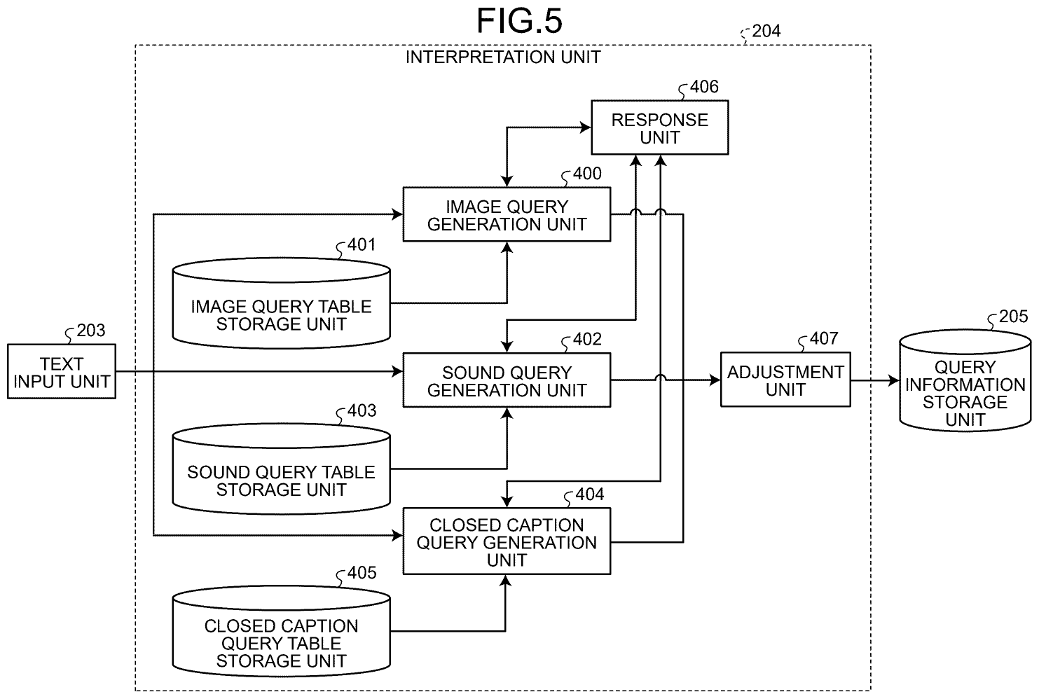

Next, an example of the functional configuration of the interpretation unit 204 will be explained. FIG. 5 is a diagram illustrating an example of the functional configuration of the interpretation unit 204 according to the first embodiment. The interpretation unit 204 according to the first embodiment includes an image query generation unit 400, an image query table storage unit 401, a sound query generation unit 402, a sound query table storage unit 403, a closed caption query generation unit 404, a closed caption query table storage unit 405, a response unit 406, and an adjustment unit 407.

The response unit 406 is a question-and-answer system configured to output a response in text to a question input in text. For example, a question-and-answer system (Generative Artificial Intelligence (AI)) to which a large-scale language model is applied, such as ChatGPT (registered trademark), is used as the response unit 406.

The image query table storage unit 401 stores an image query table in which keywords that may be included in the texts input via the text input unit 203, search queries corresponding to those keywords, and query importance are associated. For example, keywords that are expected to appear frequently in the input texts are listed in advance by the user. Each of the keywords listed is stored in the image query table along with the appropriate search query to search for the image video element corresponding to the keyword and the query importance thereof.

The image query generation unit 400 searches for keywords included in the input text by referring to the image query table, and acquires the corresponding search queries and query importance.

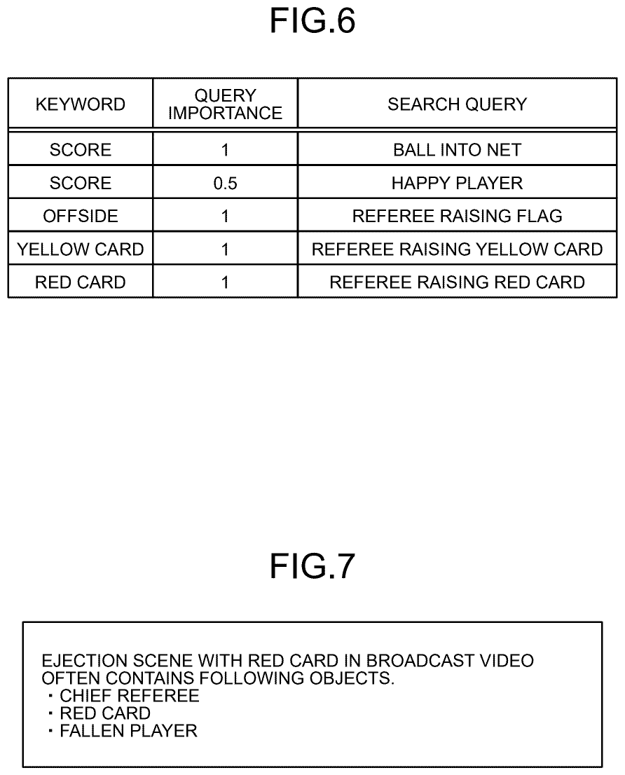

FIG. 6 is a diagram illustrating an example of the image query table according to the first embodiment. In the example in FIG. 6, when the input text is “ejection scene with red card”, for example, the keyword “red card” matches. Thus, the search query “referee raising red card” and query importance 1 are acquired from the image query table.

Furthermore, the image query generation unit 400 generates a search query using the response unit 406. The image query generation unit 400 generates a question text using “What do you see on the screen in (input text) in the broadcast video? Please list them in bullet points.” as a template for creating a question text to be input to the response unit 406. For example, when the input text is “ejection scene with red card”, “What do you see on the screen in the ejection scene with red card in the broadcast video? Please list them in bullet points.” may be the question text. The image query generation unit 400 inputs the question text to the response unit 406, and acquires a response text from the response unit 406.

FIG. 7 is a diagram illustrating a first example of the response text given by the response unit 406 according to the first embodiment. For example, when the response text illustrated in FIG. 7 is acquired, “chief referee”, “red card”, and “fallen player” listed in bullet points are extracted from the response text as search queries. The image query generation unit 400 determines the query importance corresponding to those search queries to a given constant (for example, 0.5).

Returning to FIG. 5, the sound query table storage unit 403 stores a sound query table in which keywords that may be included in the texts input from the text input unit 203, search queries corresponding to those keywords, and query importance are associated. As in the case of the image query table described above, each of the keywords listed is stored in the sound query table along with the appropriate search query to search for the sound video element corresponding to the keyword and the query importance thereof.

The sound query generation unit 402 searches for keywords included in the input text by referring to the sound query table, and acquires the corresponding search queries and query importance.

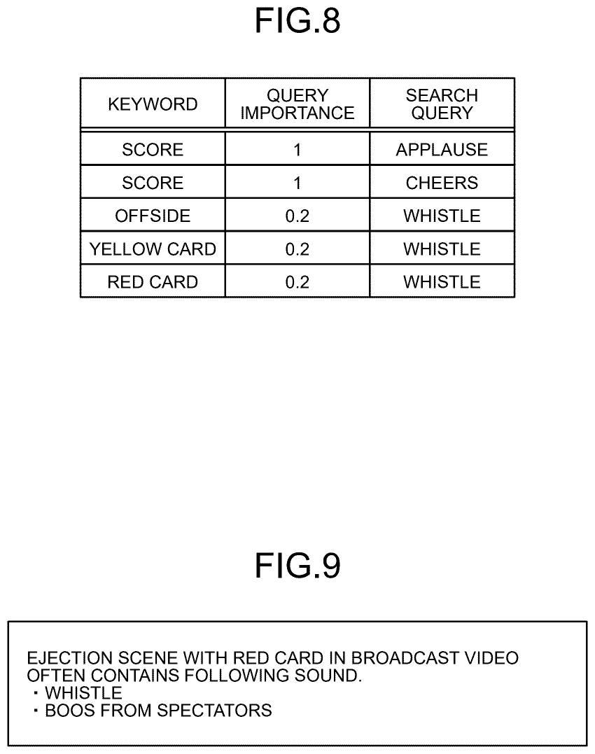

FIG. 8 is a diagram illustrating an example of the sound query table according to the first embodiment. In the example in FIG. 8, when the input text is “ejection scene with red card”, for example, the keyword “red card” matches. Thus, the search query “whistle” and query importance 0.2 are acquired.

Furthermore, the sound query generation unit 402 generates a search query using the response unit 406. The sound query generation unit 402 generates a question text using “What sound do you hear in (input text) in the broadcast video? Please list them in bullet points.” as a template for creating a question text to be input to the response unit 406. For example, when the input text is “ejection scene with red card”, “What sound do you hear in the ejection scene with red card in the broadcast video? Please list them in bullet points.” may be the question text. The sound query generation unit 402 inputs the question text to the response unit 406, and acquires a response text from the response unit 406.

FIG. 9 is a diagram illustrating a second example of the response text given by the response unit 406 according to the first embodiment. For example, when the response text illustrated in FIG. 9 is acquired, “whistle” and “boos from spectators” listed in bullet points are extracted from the response text as search queries. The sound query generation unit 402 determines the query importance corresponding to those search queries to a given constant (for example, 0.5).

Returning to FIG. 5, the closed caption query table storage unit 405 stores a closed caption query table in which keywords that may be included in the texts input from the text input unit 203, search queries corresponding to those keywords, and query importance are associated. As in the cases of the image query table and the sound query table described above, each of the keywords listed is stored in the closed caption query table along with the appropriate search query to search for the closed caption video element corresponding to the keyword and the query importance thereof.

The closed caption query generation unit 404 searches for keywords included in the input text by referring to the closed caption query table, and acquires the corresponding search queries and query importance.

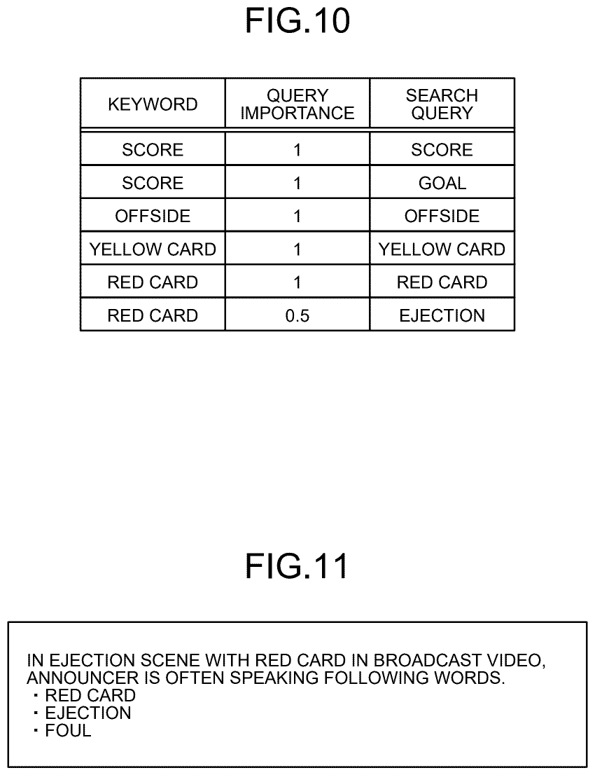

FIG. 10 is a diagram illustrating an example of the closed caption query table according to the first embodiment. In the example in FIG. 10, when the input text is “ejection scene with red card”, for example, the keyword “red card” matches. Thus, the search query “red card” and the query importance 1, and the search query “ejection” and the query importance 0.5 are acquired.

Furthermore, the closed caption query generation unit 404 generates a search query using the response unit 406. The closed caption query generation unit 404 generates a question text using “What words is the announcer speaking in (input text) in the broadcast video? Please list them in bullet points.” as a template for creating a question text to be input to the response unit 406. For example, when the input text is “ejection scene with red card”, “What words is the announcer speaking in the ejection scene with red card in the broadcast video? Please list them in bullet points.” may be the question text. The closed caption query generation unit 404 inputs the question text to the response unit 406, and acquires a response text from the response unit 406.

FIG. 11 is a diagram illustrating a third example of the response text given by the response unit 406 according to the first embodiment. For example, when the response text illustrated in FIG. 11 is acquired, “red card”, “ejection”, and “foul” listed in bullet points are extracted from the response text as search queries. The closed caption query generation unit 404 determines the query importance corresponding to those search queries to a given constant (for example, 0.5).

Returning to FIG. 5, the adjustment unit 407 receives query information from each of the image query generation unit 400, the sound query generation unit 402, and the closed caption query generation unit 404, and adjusts the query importance for corresponding to each of the search queries.

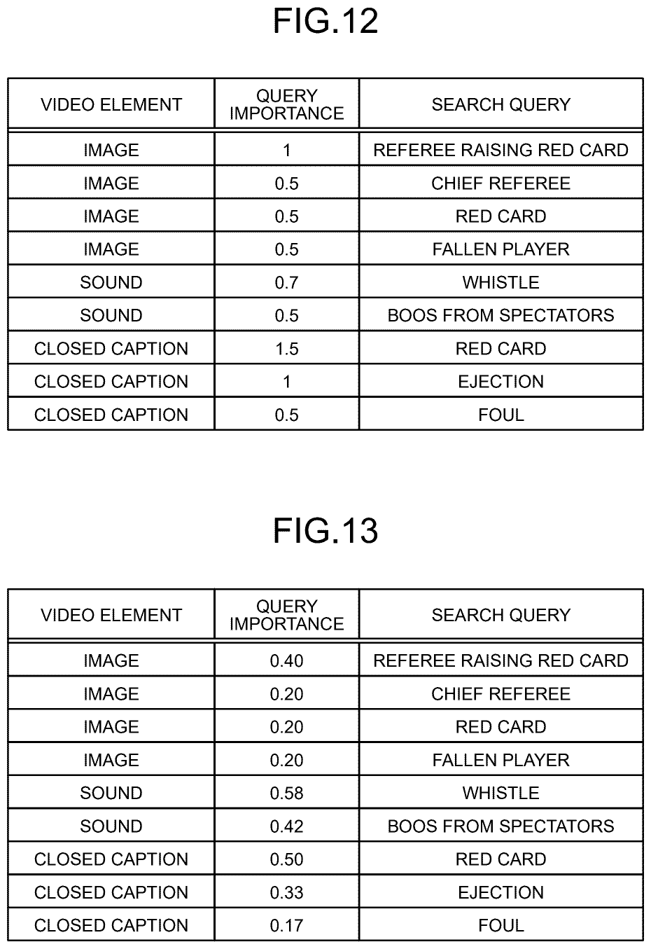

FIG. 12 is a diagram illustrating an example of the query information according to the first embodiment. The query information according to the first embodiment includes video elements, query importance, and search queries. The video element is indicative of a search-target video element. In the first embodiment, the video element is an image, a sound, or a closed caption.

In case of plural search queries that are identical for the video elements, processing is performed to add each query importance of the identical search queries to integrate into a single item. In the example in FIG. 12, the search query “whistle” for the sound video element exists in the sound query table and it is also generated from the response unit 406. Thus, each of the query importance (0.2 and 0.5) thereof is added together to be integrated as one item with the query importance of 0.7.

Since the number of search queries and values of the query importance for each of the video elements are different, the adjustment unit 407 adjusts the query importance by performing normalization processing on the query importance to align the contributions of each of the video elements. Specifically, the adjustment unit 407 performs normalization such that the sum total of the query importance of each of the video elements equals to 1.

FIG. 13 is a diagram illustrating an example of the query information after adjusting the query importance according to the first embodiment. The adjustment unit 407 outputs the query information after performing adjustment of the query importance.

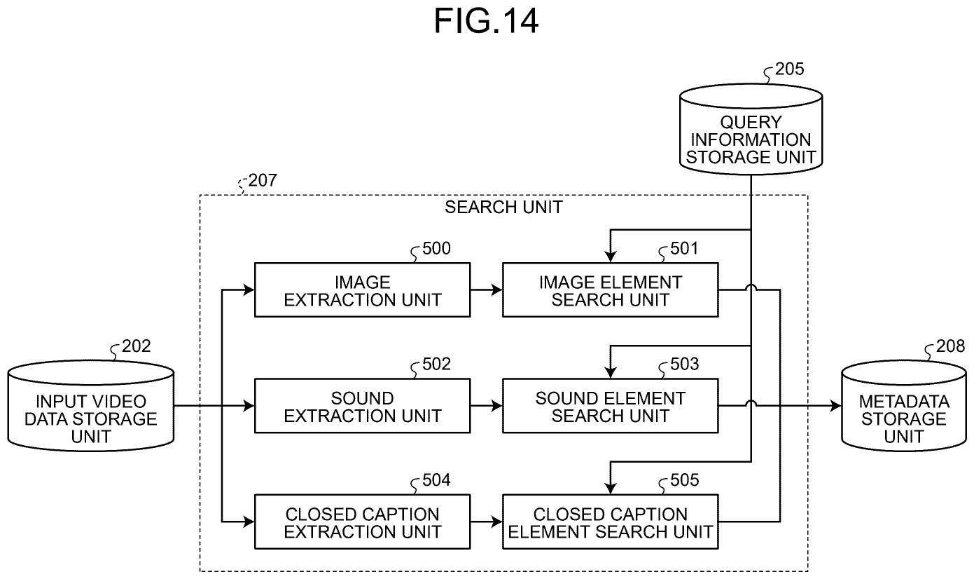

FIG. 14 is a diagram illustrating an example of the functional configuration of the search unit 207 according to the first embodiment. The search unit 207 according to the first embodiment includes an image extraction unit 500, an image element search unit 501, a sound extraction unit 502, a sound element search unit 503, a closed caption extraction unit 504, and a closed caption element search unit 505.

The image extraction unit 500 extracts image data from the video data stored in the input video data storage unit 202 described above, and inputs the image data to the image element search unit 501.

The image element search unit 501 searches for the image data of each frame input from the image extraction unit 500 with each of the search queries corresponding to the image elements stored in the query information storage unit 205 described above.

For example, search processing of the image element search unit 501 is achieved by processing of answering questions regarding images described in text (Visual Question Answering (VQA)).

The image element search unit 501 prepares “Is (search query) included?” as a template for the question to be input into the VQA, and generates a question by embedding the search query. For example, when the search query is “referee raising red card”, the question “Does it include referee raising red card?” and the image data are input to the VQA, and a response Yes or No is output.

When the response is Yes, the image element search unit 501 acquires a value representing the probability of Yes from the VQA. The image element search unit 501 calculates the mean value of the probability of Yes as the search reliability score (an example of the reliability of the search result), with the time of the first frame in the segment where the response Yes continues being the start time and the time of the last frame being the end time.

In other words, the image element search unit 501 searches for image elements by the VQA using a question text including a search query, and determines a larger search reliability score for the video segment that matches the search conditions expressed by the question text.

The image element search unit 501 calculates, as the video importance score, the product of the query importance score corresponding to the search query and the search reliability score. The image element search unit 501 outputs the start time, the end time, and the video importance score as the search result for each of the search queries.

The sound extraction unit 502 extracts sound data from the video data stored in the input video data storage unit 202 described above, and inputs the sound data to the sound element search unit 503.

The sound element search unit 503 searches for each frame of the sound data output from the sound extraction unit 502 divided in a given length, with each of the search queries corresponding to sound elements stored in the query information storage unit 205 described above.

For example, search processing of the sound element search unit 503 is achieved by processing of answering questions regarding sound described in text (Audio Question Answering (AQA)).

The sound element search unit 503 prepares “Do you hear (search query)?” as a template for the question to be input into the AQA, and generates a question by embedding the search query. For example, when the search query is “whistle”, the question “Do you hear whistle?” and one frame of sound data is inputted to the AQA, and a response Yes or No is output.

When the response is Yes, the sound element search unit 503 acquires a value representing the probability of Yes from the AQA. The sound element search unit 503 calculates the mean value of the probability of Yes as the search reliability score, with the start time of the first frame in the segment where the response Yes continues being the start time of the detection result and the end time of the last frame being the end time of the detection result.

In other words, the sound element search unit 503 searches for sound elements by the AQA using a question text including a search query, and determines a larger search reliability score for the video segment that matches the search conditions expressed by the question text.

The sound element search unit 503 also calculates, as the video importance score, the product of the query importance score corresponding to the search query and the search reliability score. The sound element search unit 503 outputs the start time, the end time, and the video importance score as the search result for each of the search queries.

The closed caption extraction unit 504 extracts closed captions from the video data stored in the input video data storage unit 202, and inputs the closed captions to the closed caption element search unit 505. The closed caption includes the text to be displayed as subtitles and information on the time segment in which the text is displayed.

The closed caption element search unit 505 searches for the text of closed caption input from the closed caption extraction unit 504 with each of the search queries corresponding to the closed caption elements stored in the query information storage unit 205 described above.

For example, the search processing of the closed caption element search unit 505 is achieved by string matching. The closed caption element search unit 505 takes the start time and end time of the time segment displaying the subtitle text matching the search query as the start time and end time of the search result, the query importance score of the search query as the video importance score, and outputs the start time, end time, and video importance score.

### Example of Video Processing Method

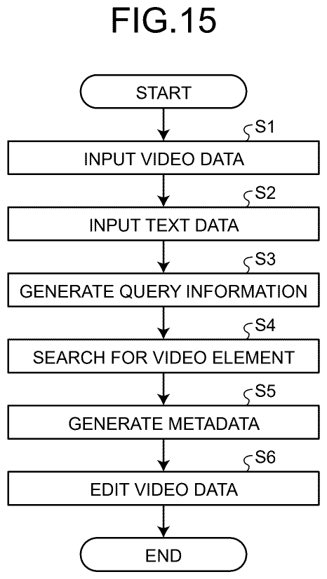

FIG. 15 is a flowchart illustrating an example of a video processing method according to the first embodiment. First, the video input unit 201 receives input of video data as an edit target by an operation input made by the user (step S1). Next, the text input unit 203 receives input of text data representing scenes included in the video data input at step S1 by an operation input made by the user (step S2).

Then, the interpretation unit 204 generates query information used to search for a video element from the text data input at step S2 (step S3). Next, the search unit 207 uses the query information generated at step S3 to search for the video elements (the image, the sound, and the subtitle in the first embodiment) of the video data input at step S1 (step S4), and generates metadata for the video data based on the search result (step S5).

Then, the generation unit 210 edits the video data input at step S1 by referring to the metadata generated at step S5 to generate a digest video of the designated digest video length (step S6).

As described above, the video processing device 200 according to the first embodiment enables video processing as intended by the user in response to the request from the user.

For example, with the video processing device 200 according to the first embodiment, it is possible to generate appropriate search queries to search for different video elements such as an image, a sound, and a closed caption based on the text describing the scene desired by the user, and search for different video elements with each of the search queries. This makes it possible to generate metadata on which the request of the user is appropriately reflected.

Also, for example, by the video processing device 200 according to the first embodiment generating a digest video of a short time using the generated metadata, the user can efficiently view the desired video.

Furthermore, for example, the video processing device 200 according to the first embodiment generates a plurality of search queries for each of the video elements, and gives a query importance score to each of the search queries to reflect upon the query importance scores of the search result. This makes it possible to clearly rank the importance of the scenes and generate an appropriate digest video by giving priority to the more important scenes. Furthermore, even when the generated search query does not match the intention of the user, it is possible to generate a digest video desired by the user by accepting modifications from the user using the interface by the editing unit 206.

Moreover, when generating a digest video, the video processing device 200 according to the first embodiment can generate a digest video without feeling a sense of discomfort over discontinuities in the connecting parts by editing in a scene unit, for example.

### Modification Example of First Embodiment

A modification example of the first embodiment will be explained below. While the image element search unit 501 according to the first embodiment is explained to use VQA for searching, it is also possible to use a combination of VQA and object recognition. Object recognition is configured to recognize given objects (for example, car, person, dog, ball, cup, and the like) in an image by image feature learning or the like, and recognition accuracy of the objects included in the recognition target is generally higher than the case of using VQA.

Therefore, as a modification example of the first embodiment, the image element search unit 501 may be configured to acquire a search result using object recognition when the object represented by the search query is included in the recognition target of object recognition, and to acquire a search result using VQA in other cases. The use of dedicated object recognition for the objects that frequently appear in the requests of the user has the effect of improving the recognition accuracy.

Similarly, while the sound element search unit 503 according to the first embodiment is explained to use AQA for searching, it is also possible to use a combination of AQA and sound recognition. Sound recognition is so composed as to recognize given sound sources (for example, applause, cheers, music, whistle, an engine sound, and the like) in the sound by acoustic feature learning or the like, and recognition accuracy of the sound sources included in the recognition target is generally higher than the case of using AQA.

Accordingly, as a modification example of the first embodiment, the sound element search unit 503 may be configured to acquire a search result using sound recognition when the sound source represented by the search query is included in the recognition target of sound recognition, and to acquire a search result using AQA in other cases. The use of dedicated sound recognition for the sound sources that frequently appear in the requests of the user has the effect of improving the recognition accuracy.

Furthermore, while the generation unit 210 according to the first embodiment is explained to edit a scene as a unit, it may be configured to edit without using scene boundaries. For example, the generation unit 210 may sort the search results stored in the metadata storage unit 208 according to the video importance in the order from the highest-rank search result, and cut out and connect video data of a given length, including the start time to end time of the search result. With such a configuration, it is possible to generate a digest video in which the desired scenes can be viewed in a shorter time.

### Second Embodiment

Next, a second embodiment will be explained. In the description of the second embodiment, similar explanations as those of the first embodiment will be omitted and the points different from the first embodiment will be explained.

### Example of Functional Configuration

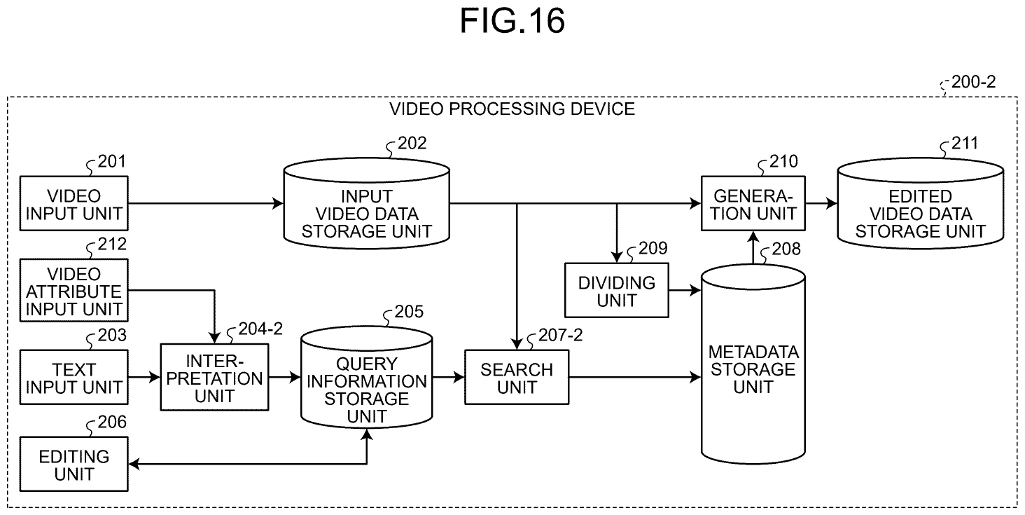

FIG. 16 is a diagram illustrating an example of the functional configuration of a video processing device 200-2 according to the second embodiment. The video processing device 200-2 according to the second embodiment includes a video input unit 201, an input video data storage unit 202, a text input unit 203, an interpretation unit 204-2, a query information storage unit 205, an editing unit 206, a search unit 207-2, a metadata storage unit 208, a dividing unit 209, a generation unit 210, an edited video data storage unit 211, and a video attribute input unit 212

In the first embodiment, the image, the sound, and the closed caption as video elements are the search targets. However, a face in an image, text in an image, and a voice in the sound as video elements are the search targets in the second embodiment. Thus, in the configuration of the video processing device 200-2 according to the second embodiment, the interpretation unit 204-2 and the search unit 207-2 are different from the interpretation unit 204 and the search unit 207 of the first embodiment. Furthermore, the video attribute input unit 212 is further added in the second embodiment.

The video attribute input unit 212 acquires video attribute data by receiving input of the video attribute data related to the video data input from the video input unit 201. When the video data is a broadcast program, for example, the video attribute data includes the program name, broadcast date and time, program genre, names of cast members, and the like. Such video attribute data may be acquired from the header of the video data or from the file name of the video data. Furthermore, an input interface for the video attribute data may be provided to receive an operation input indicating the video attribute data from the user.

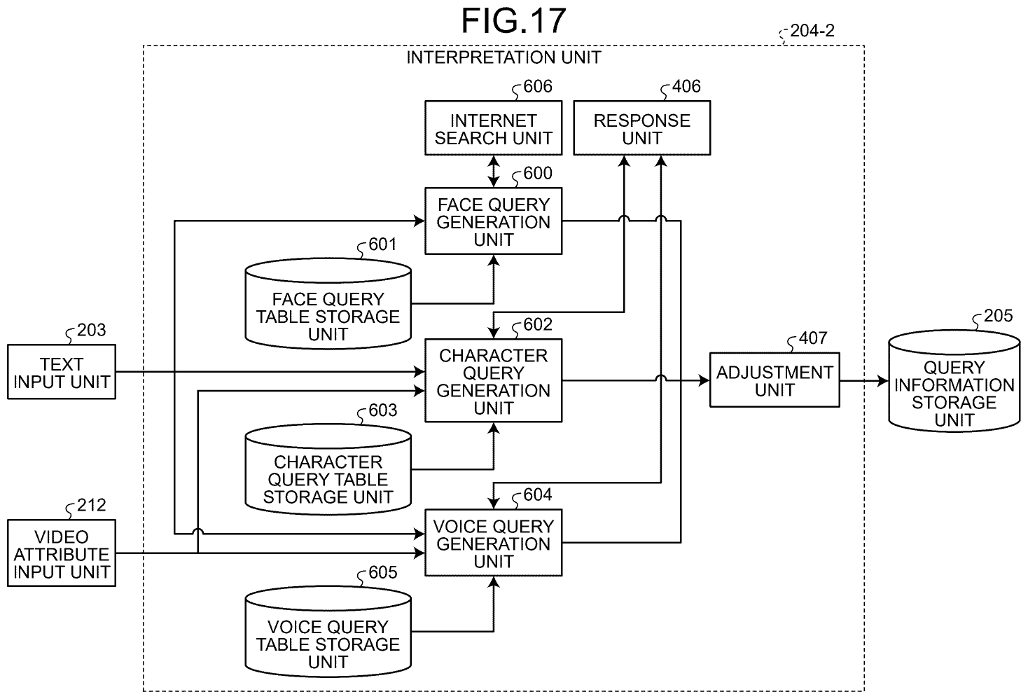

FIG. 17 is a diagram illustrating an example of the functional configuration of the interpretation unit 204-2 according to the second embodiment. The interpretation unit 204-2 according to the second embodiment includes a response unit 406, an adjustment unit 407, a face query generation unit 600, a face query table storage unit 601, a character query generation unit 602, a character query table storage unit 603, a voice query generation unit 604, a voice query table storage unit 605, and an Internet search unit 606.

The face query table storage unit 601 stores a face query table in which keywords that may be included in the texts input from the text input unit 203, search queries corresponding to those keywords, and query importance are associated. The search query in the face query table is the face image data of a person indicated by the keyword. For example, names of persons that are expected to appear frequently in the input texts are listed in advance by the user as keywords. Each of the keywords listed is stored in the image query table along with the appropriate search query to search for image video elements corresponding to that keyword and the query importance thereof. The search query is the face image data of the person collected from the Internet, for example.

The face query generation unit 600 searches for keywords included in the input text by referring to the face query table, and acquires the corresponding search queries and query importance.

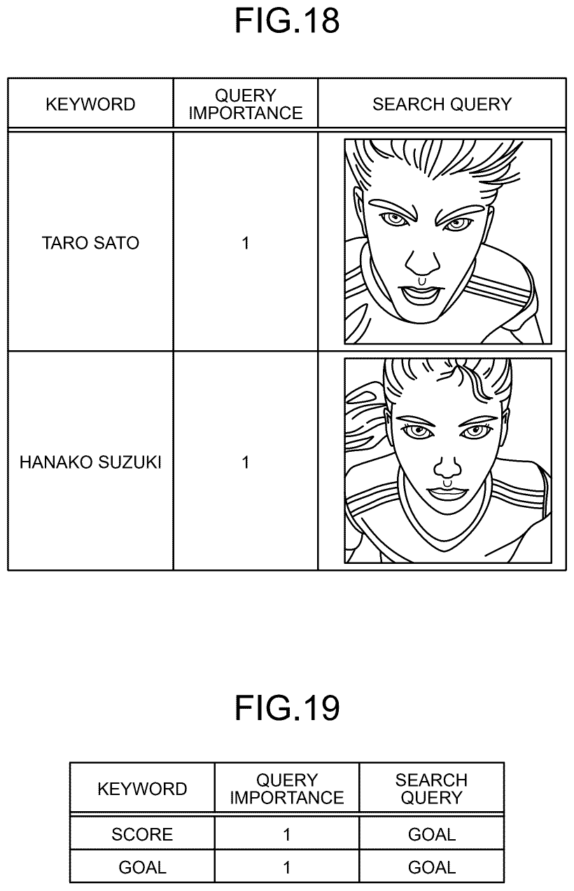

FIG. 18 is a diagram illustrating an example of the face query table according to the second embodiment. In the example in FIG. 18, when the input text is “scene where Jiro Suzuki scored”, for example, the keyword “Jiro Suzuki” matches. Thus, the corresponding image data as the search query and the query importance 1 are acquired from the face query table.

Furthermore, the face query generation unit 600 generates a search query using the Internet search unit 606. The face query generation unit 600 generates the Internet search text using “face image of (person's name)” as a template to be input to the Internet search unit 606. The character string to be applied to (person's name) is acquired by extracting a proper noun from the input text. For example, when the input text is “scene where Jiro Suzuki scored”, the face query generation unit 600 acquires “Jiro Suzuki” as (person's name) from the input text. In this case, the Internet search text may be “face image of Jiro Suzuki”.

The Internet search unit 606 connects to the Internet via the communication device 307, and inputs the Internet search text into a search site on the Internet to acquire face image data. The Internet search unit 606 acquires a given number of (for example, two) pieces of higher-rank image data from among the image data of the search result, and inputs the given number of pieces of image data including the face images and search ranking to the face query generation unit 600.

Upon acquiring the face images and search ranking from the Internet search unit 606, the face query generation unit 600 assigns a given query importance (for example, 0.5 for the first place, 0.3 for the second place) according to the search ranking.

The face query generation unit 600 inputs, to the adjustment unit 407, the search query acquired from the face query table and the search query acquired from the Internet search unit 606.

The character query table storage unit 603 stores a character query table in which keywords that may be included in the texts input from the text input unit 203, search queries corresponding to the keywords, and query importance are associated. For example, keywords that are expected to appear frequently in the input texts are listed in advance by the user. Each of the keywords listed is stored in the character query table along with the appropriate search query for a character video element in an image and the query importance thereof.

The character query generation unit 602 searches for keywords included in the input text by referring to the character query table, and acquires the corresponding search queries and query importance.

FIG. 19 is a diagram illustrating an example of the character query table according to the second embodiment. In the example in FIG. 19, when the input text is “scene where Jiro Suzuki scored”, for example, the keyword “score” matches. Thus, the search query “GOAL” and query importance 1 are acquired.

Furthermore, the character query generation unit 602 generates a search query using the video attribute input from the video attribute input unit 212 and the response unit 406. First, the character query generation unit 602 generates a prompt using “Please answer the following questions about a broadcast program whose name is (program name), genre is (program genre), broadcast station is (broadcast station), broadcast date is (broadcast date), and caste members are (cast members).” as a template for creating a prompt to be input to the response unit 406.

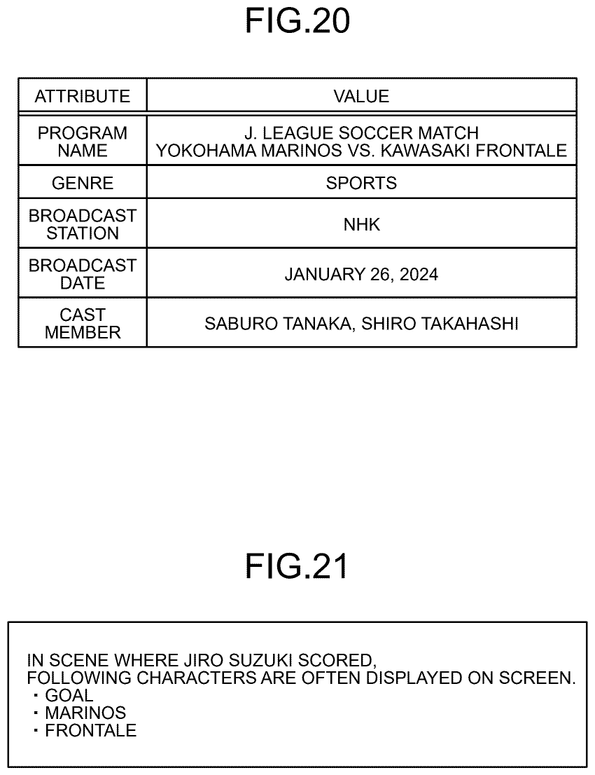

FIG. 20 is a diagram illustrating an example of the video attribute data according to the second embodiment. For example, in the case of the video attribute data illustrated in FIG. 20, “Please answer the following questions about the broadcast program whose name is J. League Soccer Match Yokohama Marinos vs. Kawasaki Frontale, genre is sports, broadcast station is NHK, broadcast date is Jan. 26, 2024, and cast members are Saburo Tanaka and Shiro Takahashi.” is generated as the prompt. The prompt is input into the response unit 406 before the question text is input.

The character query generation unit 602 generates a question text using “What characters are displayed on the screen in (input text)? Please list them in bullet points.” as a template for creating a question text. For example, when the input text is “scene where Taro Sato scored”, “What characters are displayed on the screen in the scene where Taro Sato scored? Please list them in bullet points.” may be the question text. The character query generation unit 602 inputs the question text to the response unit 406, and acquires a response text from the response unit 406.

FIG. 21 is a diagram illustrating an example of the response text given by the response unit 406 according to the second embodiment. For example, when the response text illustrated in FIG. 20 is acquired, “GOAL”, “Marinos”, and “Frontale” listed in bullet points are extracted from the response text as search queries. The character query generation unit 602 determines the query importance corresponding to those search queries to a given constant (for example, 0.5).

Returning to FIG. 17, the voice query table storage unit 605 stores a voice query table in which keywords that may be included in the texts input from the text input unit 203, search queries corresponding to those keywords, and query importance are associated. The voice query table stores keywords included in the voices uttered by the announcer, cast members, and the like, appropriate search queries for the video elements of the voices, and the query importance thereof.

The voice query generation unit 604 searches for keywords included in the input text by referring to the voice query table, and acquires the corresponding search queries and query importance.

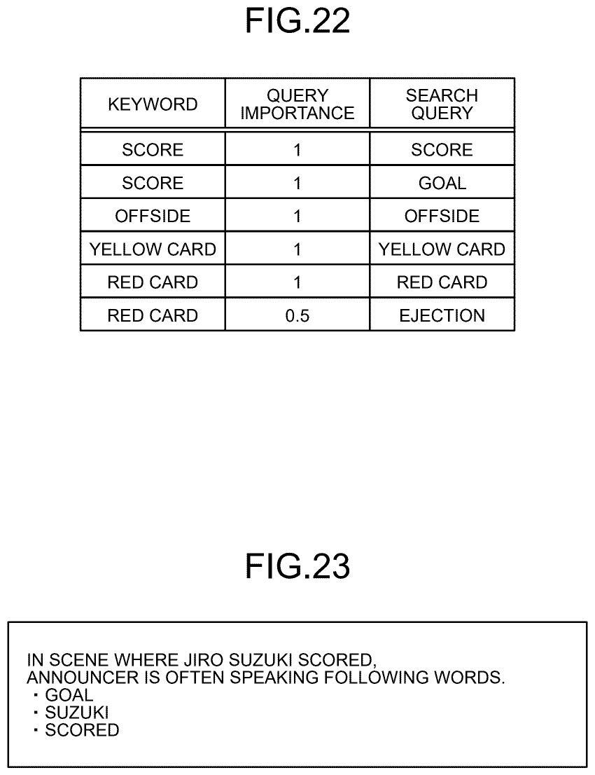

FIG. 22 is a diagram illustrating an example of the voice query table according to the second embodiment. For example, when the input text is “scene where Jiro Suzuki scored”, the keyword “score” matches. Thus, the search query “score” and query importance 1, and the search query “GOAL” and query importance 1 are acquired.

Furthermore, the voice query generation unit 604 generates a search query using the video attribute input from the video attribute input unit 212 and the response unit 406. First, as in the case of the processing by the character query generation unit 602 described above, a prompt is generated.

For example, in the case of the video attribute data illustrated in FIG. 20 described above, “Please answer the following questions about the broadcast program whose name is J. League Soccer Match Yokohama Marinos vs. Kawasaki Frontale, genre is sports, broadcast station is NHK, broadcast date is Jan. 26, 2024, and cast members are Saburo Tanaka and Shiro Takahashi.” is generated as the prompt. The prompt is input into the response unit 406 before the question text is input.

The voice query generation unit 604 generates a question text using “What words is the announcer speaking in (input text)? Please list them in bullet points.” as a template for creating a question text to be input to the response unit 406. For example, when the input text is “scene where Taro Sato scored”, “What words is the announcer speaking in the scene where Taro Sato scored? Please list them in bullet points.” may be the question text. The voice query generation unit 604 inputs the question text to the response unit 406 and acquires a response text from the response unit 406.

FIG. 23 is a diagram illustrating an example of the response text given by the response unit 406 according to the second embodiment. For example, when the response text illustrated in FIG. 23 is acquired, “GOAL”, “Suzuki”, and “scored” listed in bullet points are extracted from the response text as search queries. The voice query generation unit 604 determines the query importance corresponding to those search queries to a given constant (for example, 0.5).

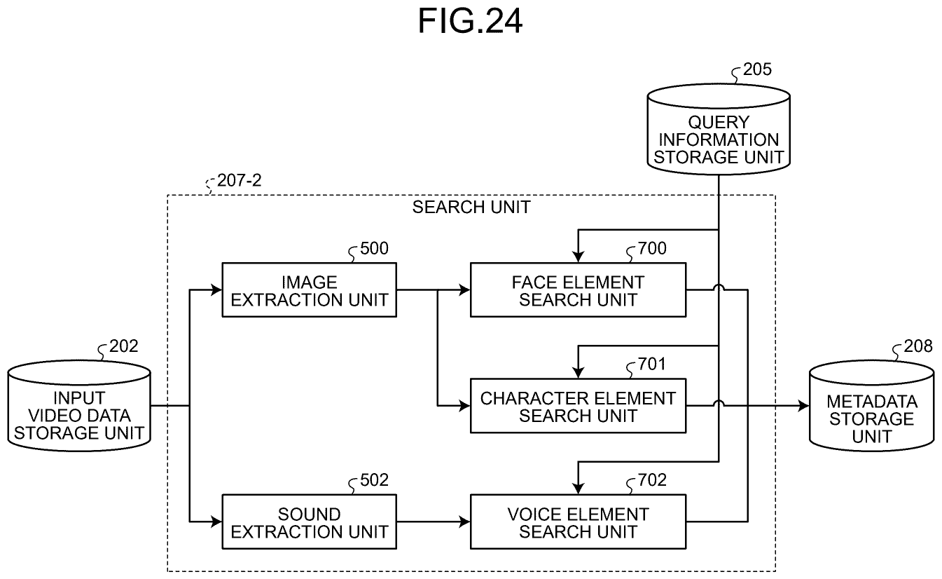

FIG. 24 is a diagram illustrating an example of the functional configuration of the search unit 207-2 according to the second embodiment. The search unit 207-2 according to the second embodiment includes an image extraction unit 500, a sound extraction unit 502, a face element search unit 700, a character element search unit 701, and a voice element search unit 702. The explanations of the image extraction unit 500 and the sound extraction unit 502 are similar to those of the first embodiment and are therefore omitted.

The face element search unit 700 searches for the image data of each frame input from the image extraction unit 500 with each of the search queries corresponding to the face elements stored in the query information storage unit 205 described above.

For example, search for the face element is performed by a method such as detecting a face region from image data, calculating the feature value of the image of the face region, and performing threshold processing for acquiring similarity between the feature value of the face image acquired from the search query and the feature value of the image of the face region.

Furthermore, for example, for a person appearing frequently, search for the face element is performed by a method such as learning and storing a face recognition model in advance and, when the name of the person of the stored face recognition model matches the name of the person as the search query, detecting it by using the stored face recognition model.

The face element search unit 700 calculates the mean value of the probability of the face being the person concerned as the search reliability score, with the time of the first frame in the segment where the frames having the detected face continues being the start time and the time of the last frame being the end time. The face element search unit 700 also calculates the video importance score as the product of the query importance score corresponding to the search query and the search reliability score. The face element search unit 700 outputs the start time, the end time, and the video importance score as the search result for each of the search queries.

The character element search unit 701 searches for the image data of each frame input from the image extraction unit 500 with each of the search queries corresponding to the character elements stored in the query information storage unit 205 described above. The character element search unit 701 detects character regions from the image data, performs character recognition processing on the character regions to generate a text, and performs string matching between the text and the search query.

The character element search unit 701 calculates the mean value of the reliability of the recognition results of the character strings that match the search query as the search reliability score, with the time of the first frame in the segment where the frames in which the search query is detected continues being the start time and the time of the last frame being the end time. The character element search unit 701 also calculates the video importance score as the product of the query importance score corresponding to the search query and the search reliability score. The character element search unit 701 outputs the start time, the end time, and the video importance score as the search result for each of the search queries.

The voice element search unit 702 searches for the sound data input from the sound extraction unit 502 with each of the search queries corresponding to the voice elements stored in the query information storage unit 205 described above. The voice element search unit 702 generates a text by performing voice recognition processing on the sound data, and performs string matching between the text and the search query.

The voice element search unit 702 calculates the mean value of reliability of recognition results of the character strings that match the search query as the search reliability score, with the beginning of the speaking segment of the sound data that matches the search query being the start time and the end thereof being the end time. The voice element search unit 702 also calculates the video importance score as the product of the query importance score corresponding to the search query and the search reliability score. The voice element search unit 702 outputs the start time, end time, and video importance score as the search results for each of the search queries.

### Example of Video Processing Method

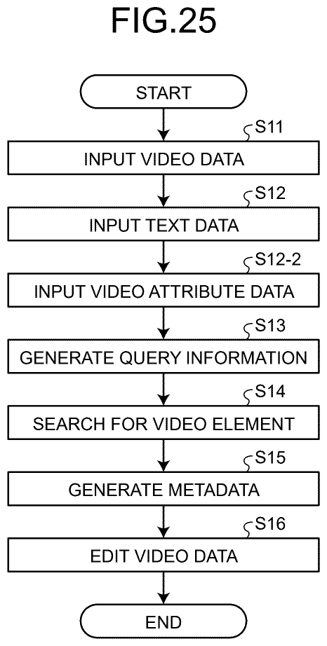

FIG. 25 is a flowchart illustrating an example of a video processing method according to the second embodiment. Steps S11 and S12 are similar to steps S1 and S2 of the first embodiment (see FIG. 15), so the explanations thereof are omitted.

The video attribute input unit 212 receives input of the video attribute data related to the video data input at step S11 (step S12-2). Next, the interpretation unit 204-2 generates query information used to search for a video element, from the text data input at step S12 and the video attribute data input at step S12-2 (step S13).

Then, the search unit 207-2 uses the query information generated at step S13 to search for the video elements (face, character, and voice in the second embodiment) of the video data input at step S11 (step S14), and generates metadata for the video data based on the search result (step S15).

Step S16 is similar to step S6 of the first embodiment (see FIG. 15), so the explanation thereof is omitted.

As described above, the video processing device 200-2 according to the second embodiment generates appropriate search queries to search for different video elements such as face, character, and voice based on the text describing the scene desired by the user, and search for the video data with each of the search queries. This makes it possible to generate metadata on which the request of the user is appropriately reflected.

Additionally, by generating a digest video of a short time using the generated metadata with the use of the video processing device 200-2 according to the second embodiment, the user can efficiently view the desired video.

Furthermore, when interpreting the input text and generating a search query, the video processing device 200-2 according to the second embodiment can generate an appropriate search query by referring to the video attribute. For example, when “soccer” is included in the program name of the video attribute, it becomes clear that the “GOAL” in the input text is a soccer goal, thus enabling a more appropriate search.

### Modification Example of Second Embodiment

A modification example of the second embodiment will be explained below. While the face query table storage unit 601 according to the second embodiment is explained to store one piece of face image data per person, it may store a plurality of pieces. By increasing the number of pieces of face image data, the detection accuracy can be improved.

Furthermore, while the face query generation unit 600 according to the second embodiment is explained to generate a search query using the Internet search unit 606, a face image may be generated by inputting “Please generate a face image of (person's name)” in the response unit 406. Furthermore, a face image may be generated by referring to the video attribute from the video attribute input unit 212 and inputting “Please generate a face image of (person's name) appearing in (program name)”. This makes it possible to generate queries that are easy to match including background, thereby improving the detection accuracy.

Furthermore, while the video attribute data input from the video attribute input unit 212 is explained to be the program name, genre, broadcast station, broadcast date, and cast members, information other than those may also be included in the video attribute data. For example, the video attribute data may further include the broadcast time, an introduction of the program, and the like.

The functions of the video processing device 200 (200-2) according to the first and second embodiments explained above may be achieved by a computer program.

For example, a computer program to be executed by the video processing device 200 (200-2) is provided as a computer program product by being recorded on computer readable storage media such as a memory card, a hard disk, a CD-RW, a CD-ROM, a CD-R, a DVD-RAM, and a DVD-R in an installable or executable format file.

For example, the computer program to be executed by the video processing device 200 (200-2) may also be configured to be stored on a computer connected to a network such as the Internet, and to be provided by being downloaded via the network.

Furthermore, the computer program to be executed by the video processing device 200 (200-2) may be configured to be provided via a network such as the Internet without being downloaded, for example.

Furthermore, the computer program of the video processing device 200 (200-2) may be configured to be provided by being installed in advance in the above-described ROM 303 or the like, for example.

Some or all of the functions of the video processing device 200 (200-2) according to the first and second embodiments may be achieved not by a computer program (software) but by hardware such as an integrated circuit (IC).

Furthermore, each of the functions may be achieved by using a plurality of processors. In that case, each of the processors may achieve a single function or two or more functions among a plurality of functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video processing device that receives text data representing a scene included in input first video data, the video processing device comprising:
one or more hardware processors configured to function as:
an interpretation unit that interprets the text data and generates query information used to search for a video element of the first video data; and
a search unit that searches for the video element of the first video data using the query information, generates metadata of the first video data based on a search result, and stores the metadata in a storage unit.

2. The video processing device according to claim 1, wherein
the query information includes a search query for searching for the video element; and query importance that is indicative of an importance degree of the search query, and
the interpretation unit makes the query importance to be higher as relevance between the text data and the search query is greater.

3. The video processing device according to claim 2, wherein
the metadata includes time information that is indicative of a searched video segment; and video importance that is indicative of an importance degree of the video segment, and
the search unit calculates the video importance based on reliability of the search result and the query importance.

4. The video processing device according to claim 3, wherein the search unit searches for the video element by Visual Question Answering referred to as VQA or Audio Question Answering referred to as AQA using a question text including the search query, and determines the reliability of the search result to be higher for a video segment that matches a search condition represented by the question text.

5. The video processing device according to claim 3, wherein the one or more hardware processors are configured to further function as a generation unit that generates second video data that is shorter than the first video data by editing the first video data based on the video importance.

6. The video processing device according to claim 5, wherein the one or more hardware processors are configured to further function as a dividing unit that divides the first video data into a plurality of scenes by analyzing the first video data, wherein
the metadata further includes a boundary time indicative of a boundary of the scenes, and
the generation unit generates the second video data by selecting and concatenating scenes that include video segments with the video importance that is higher based on a given video length in order of an earlier boundary time.

7. The video processing device according to claim 1, wherein the one or more hardware processors are configured to further function as an editing unit that edits the query information in response to an operation input made by a user.

8. The video processing device according to claim 1, wherein the video element includes at least one of an image, a sound, and a subtitle.

9. A video processing method implemented by a computer of a video processing device that receives text data representing a scene included in input first video data, the video processing method comprising:
interpreting the text data and generating query information used to search for a video element of the first video data; and
searching for the video element of the first video data using the query information, generating metadata of the first video data based on a search result, and storing the metadata in a storage unit.

10. A computer program product having a non-transitory computer readable medium including programmed instructions stored thereon, wherein the instructions, when executed by a computer that receives text data representing a scene included in input first video data, cause the computer to function as:
an interpretation unit that interprets the text data and generates query information used to search for a video element of the first video data; and
a search unit that searches for the video element of the first video data using the query information, generates metadata of the first video data based on a search result, and stores the metadata in a storage unit.
